(19) United States
(12) Patent Application Publication
(10) Pub. No.: US 2021/0123673 A1
(43) Pub. Date: Apr. 29, 2021

(54) Solid Material Drying System

(71) Applicant: Tobacco Research Institute of Chinese Academy of Agricultural Sciences, Qingdao (CN)

(72) Inventors: Jie Wang, Qingdao (CN); Jing Wang, Qingdao (CN); Fenglong Wang, Qingdao (CN); Jinguang Yang, Qingdao (CN); Lili Shen, Qingdao (CN)

(73) Assignee: Tobacco Research Institute of Chinese Academy of Agricultural Sciences, Qingdao (CN)

(21) Appl. No.: 17/082,081

(22) Filed: Oct. 28, 2020

(30) Foreign Application Priority Data
Oct. 29, 2019 (CN) 201911037621.6

(51) Int. Cl. F26B 5/00; F26B 11/18; F26B 25/14

(52) U.S. Cl. CPC F26B 5/00; F26B 25/14; F26B 11/181

(57) ABSTRACT

The disclosure discloses a solid material drying system, including a drying tower and a closed annular conveyor belt at the bottom of the drying tower. A solid material enters the drying tower through the conveyor belt, and a first airflow moves towards the top of the drying tower from the bottom of the drying tower through the conveyor belt. Side walls of the drying tower are provided with several openings, and a second airflow moves towards the outside of the drying tower from the inside of the drying tower. Blocking plates that can block the openings are disposed at positions close to and above the openings inside the drying tower, and the blocking plates are hinged with the side walls of the drying tower. The disclosure is suitable for drying solid materials, and can be efficiently and universally applied to the drying of various types of solid materials.

### TECHNICAL FIELD

The disclosure relates to the technical field of material drying, and in particular to a solid material drying system.

### BACKGROUND

Solid materials, such as granular fertilizers or fertilizer spikes, have a high moisture content during the preparation process. In order to make the materials easy to store, transport and use or to make the materials meet the requirements of further processing, the excessive water needs to be removed from the materials. An existing material drying system generally implements drying through the relative motion of a material and an airflow, that is, the material falls by gravity, and the airflow moves upwards. However, to enable a material to fall by gravity, the material needs to be fed all at once or intermittently. Feeding a large quantity all at once can easily cause uneven drying, and intermittently feeding in batches is likely to cause accumulation of subsequent materials, which is not conducive to continuous production. Moreover, existing drying equipment does not provide desirable drying effects because of different sizes, moisture contents, quantities, and dryness requirements. Therefore, it is necessary to propose a solution for further solving the above problems.

### SUMMARY

The disclosure is intended to provide a solid material drying system to overcome the shortcomings in the prior art.

To solve the above technical problem, the disclosure adopts the following technical solution:

The disclosure provides a solid material drying system, including a drying tower and a closed annular conveyor belt at the bottom of the drying tower. A solid material enters the drying tower through the conveyor belt, and a first airflow moves towards the top of the drying tower from the bottom of the drying tower through the conveyor belt.

Side walls of the drying tower are provided with several openings, and a second airflow moves towards the outside of the drying tower from the inside of the drying tower through the openings. Blocking plates that can block the openings are disposed at positions close to and above the openings inside the drying tower, and the blocking plates are hinged with the side walls of the drying tower. Several holes are arranged on the conveyor belt.

Preferably, several openings are arranged along a height direction of the drying tower.

Preferably, several openings are arranged along the circumferential direction of the drying tower.

Preferably, the blocking plates have a curved geometric shape, which are curved towards the lower end of the drying tower.

Preferably, the several openings are symmetrically arranged along the central axis of the drying tower.

Preferably, the several openings are staggered along the height direction of the drying tower.

Preferably, the several blocking plates are staggered along the height direction of the drying tower.

Preferably, two of the blocking plates located on opposite side walls partially overlap.

Compared with the prior art, the disclosure has the following beneficial effects:

(1) The disclosure is suitable for drying solid materials, especially granular fertilizers or fertilizer spikes, and can be efficiently and universally applied to the drying of various types of solid materials. Moreover, the disclosure can be used for drying solid materials with different sizes, moisture contents, quantities, and dryness requirements.

(2) The disclosure uses a closed annular conveyor belt to uniformly and continuously deliver materials into a drying tower and to make materials inside the drying tower spiral up, which avoids varying dryness among materials caused by accumulation of materials that occurs when a large quantity of materials are fed all at once.

(3) The disclosure uses holes on the conveyor belt to form a revolving airflow to separate materials at a spacing, thereby improving drying efficiency and drying uniformity. Moreover, the airflow in the middle part of the annular conveyor belt is unobstructed and thus has high flow rate and low pressure, so that the materials directly above the conveyor belt can gradually move closer to the middle to further reduce the accumulation of materials, which is conducive to drying, and reduces materials at the inner edge of the drying tower, facilitating material recovery.

(4) In the disclosure, outlets at different heights are arranged on side walls of the drying tower, so that materials can be discharged from the drying tower at different heights, thereby controlling the dryness of the materials.

### BRIEF DESCRIPTION OF DRAWINGS

To describe the technical solutions in the examples of the disclosure or in the prior art more clearly, the accompanying drawings required for describing the examples or the prior art will be described briefly below. Apparently, the accompanying drawings in the following description show some examples of the disclosure, and a person of ordinary skill in the art may still derive other drawings from these accompanying drawings without creative efforts.

FIG. 1 is a schematic perspective view of an example of the disclosure;

FIG. 2 is a schematic perspective view of the belt surface of the conveyor belt in an example of the disclosure;

FIG. 3 is a schematic cross-sectional view of an example of the disclosure; and

FIG. 4 is a schematic cross-sectional view of another example of the disclosure.

In the figures, 1 represents a drying tower, 2 represents a conveyor belt, 3 represents an opening, 4 represents a blocking plate, 5 represents a hole, 6 represents a material inlet, 10 represents a material-entering direction, 20 represents a first airflow direction, and 30 represents a second airflow direction.

### DETAILED DESCRIPTION

The technical solutions in the examples of the disclosure are clearly and completely described below with reference to the accompanying drawings in the examples of the disclosure. Apparently, the described examples are merely a part rather than all of the examples of the disclosure. All other examples obtained by a person of ordinary skill in the art based on the examples of the disclosure without creative efforts shall fall within the protection scope of the disclosure.

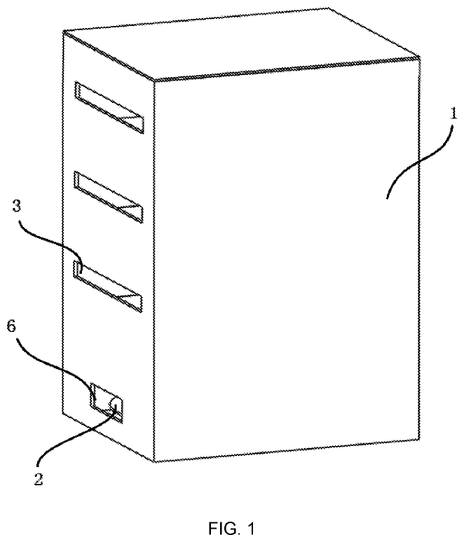

As shown in FIG. 1, a solid material drying system particularly suitable for granular fertilizers or fertilizer spikes is provided, including a drying tower 1 and a conveyor belt 2 disposed at the bottom of the drying tower 1. The conveyor belt 2 is a closed annulus, and a solid material enters the drying tower 1 through the conveyor belt 2 for drying. An opening 3 is opened by a blocking plate 4 disposed on a side wall of the drying tower to discharge a material from the drying tower 1. A material is uniformly and continuously delivered into the drying tower 1 through the conveyor belt 2 to realize continuous production. Furthermore, in a preferred example, several openings 3 are arranged along a height direction of the drying tower 1, and several may also be arranged along the circumferential direction of the drying tower 1. Outlets at different heights are arranged to facilitate the control of the discharge of materials with different dryness requirements, and a plurality of outlets are arranged at the same height to facilitate the rapid discharge of materials. Those skilled in the art may know that the drying tower 1 is provided with a material inlet 6 leading to the conveyor belt 2, and a material enters the conveyor belt 2 through the material inlet.

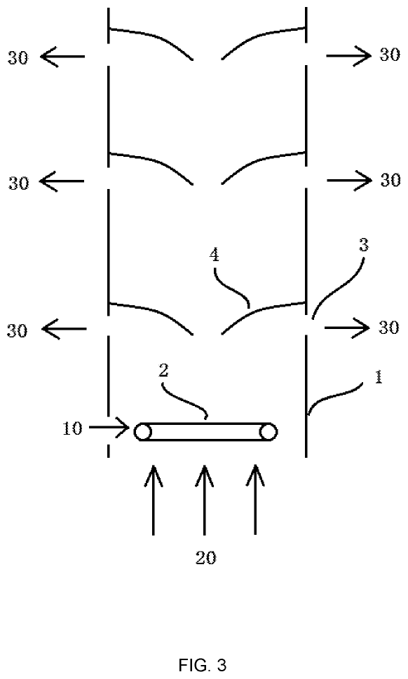

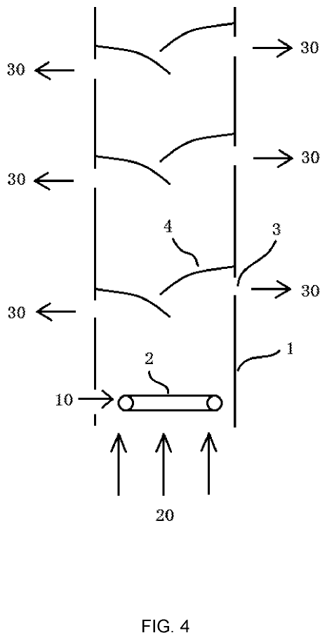

As shown in FIG. 3 and FIG. 4, a material enters the conveyor belt 2 inside the drying tower 1 in a material-entering direction 10, and is dried by a first airflow 20 that moves upwards from the bottom of the drying tower 1 to the top of the drying tower 1; and the material travels along with the closed annular conveyor belt 2. As the weight of the material is gradually reduced due to the reduction of moisture in the material, the material gradually floats and spirals up, which effectively prevents the floating materials from accumulating in the same plane and thus avoids varying dryness among materials. After the material rises to a specified height where the material is close to the outlet 3, due to a suction force of a second airflow 30 in the outlet 3, the material moves from the inside of the drying tower 1 to the outside of the drying tower 1, thereby being discharged from the drying tower 1.

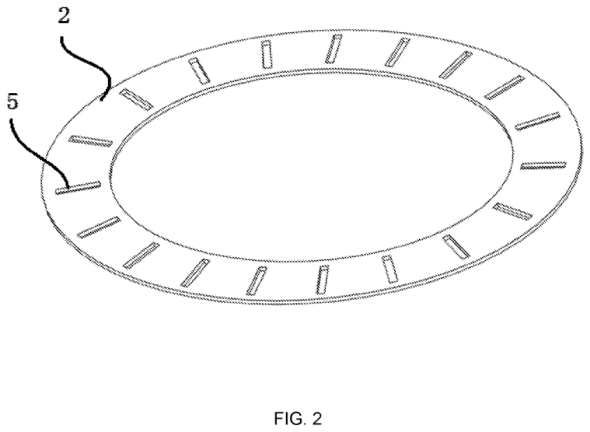

As shown in FIG. 2, in a preferred example, several holes 5 are arranged on the conveyor belt 2. When the first airflow 20 passes through the conveyor belt 2, a revolving airflow will be formed to separate materials at a spacing, thereby improving drying efficiency and drying uniformity. Moreover, the airflow in the middle part of the annular conveyor belt 2 is unobstructed and thus has high flow rate and low pressure, so that the materials directly above the conveyor belt 2 can gradually move closer to the middle to further reduce the accumulation of materials, which is conducive to drying, and reduces materials at the inner edge of the drying tower 1, facilitating material recovery.

In a specific implementation, the blocking plate 4 can be hinged with the side wall of the drying tower 1. Further, the blocking plate 4 can be disposed to have a curved geometric shape, which is curved towards the lower end of the drying tower 1 to form a downward-curving arc to guide a material into the outlet 3.

As shown in FIG. 3, several openings 3 can be symmetrically arranged along the central axis of the drying tower 1 to improve the discharge efficiency of a material.

As shown in FIG. 4, in another example, several openings 3 are staggered along the height direction of the drying tower 1; several blocking plates 4 are staggered along the height direction of the drying tower 1, and two of the blocking plates 4 on opposite side walls partially overlap to prevent materials from escaping from gaps among a plurality of blocking plates 4.

In summary, the disclosure is suitable for drying solid materials, especially granular fertilizers or fertilizer spikes, and can be efficiently and universally applied to the drying of various types of solid materials. Moreover, the disclosure can be used for drying solid materials with different sizes, moisture contents, quantities, and dryness requirements.

It is apparent for those skilled in the art that the disclosure is not limited to the details of the above exemplary examples, and that the disclosure may be implemented in other specific forms without departing from the spirit or basic features of the disclosure. The examples should be regarded as exemplary and non-limiting in every respect, and the scope of the disclosure is defined by the appended claims rather than the above description. Therefore, all changes falling within the meaning and scope of equivalent elements of the claims should be included in the disclosure. The reference numeral in the claims should not be considered as limiting the involved claims.

It should be understood that although this specification is described in accordance with the examples, not every example includes only an independent technical solution. Such a description is merely for the sake of clarity, and those skilled in the art should take the specification as a whole. The technical solutions in the examples can also be appropriately combined to form other implementations which are comprehensible for those skilled in the art.

1. A solid material drying system, comprising a drying tower and a closed annular conveyor belt at the bottom of the drying tower, wherein, a solid material enters the drying tower through the conveyor belt, and a first airflow moves towards the top of the drying tower from the bottom of the drying tower through the conveyor belt;
side walls of the drying tower are provided with several openings, and a second airflow moves towards the outside of the drying tower from the inside of the drying tower through the openings; blocking plates that can block the openings are disposed at positions close to and above the openings inside the drying tower, and the blocking plates are hinged with the side walls of the drying tower; and several holes are arranged on the conveyor belt.

2. The solid material drying system according to claim 1, wherein, several openings are arranged along a height direction of the drying tower.

3. The solid material drying system according to claim 2, wherein, several openings are arranged along a circumferential direction of the drying tower.

4. (canceled)

5. The solid material drying system according to claim 1, wherein, the blocking plates have a curved geometric shape, which are curved towards the lower end of the drying tower.

6. The solid material drying system according to claim 1, wherein, the several openings are symmetrically arranged along a central axis of the drying tower.

7. The solid material drying system according to claim 1, wherein, the several openings are staggered along a height direction of the drying tower.

8. The solid material drying system according to claim 7, wherein, the several blocking plates are staggered along the height direction of the drying tower.

9. The solid material drying system according to claim 8, wherein, two of the blocking plates located on opposite side walls partially overlap.
